(19) United States
(12) Patent Application Publication
(10) Pub. No.: US 2007/0187482 A1
(43) Pub. Date: Aug. 16, 2007

(54) Point of Sale Transaction Method and System

(76) Inventor: Alberto J. Castro, San Juan, PR (US)

Correspondence Address: CARLA FERRARI-LUGO LAW OFFICE, PO BOX 988, AGUADILLA, PR, 00605, US

(21) Appl. No.: 11/307,573

(22) Filed: Feb. 13, 2006

(51) Int. Cl. G07F 19/00; G06K 15/00; G06Q 20/00

(52) U.S. Cl. 235/379; 235/383; 705/16

(57) ABSTRACT

Disclosed is a method and system to perform an instant point of sale transaction through a communication device, comprising the use of audio tones. Such transactions may or may not be monetary in nature. The invention accordingly makes it possible for the user to either make a transaction, such as, but not limited to a payment or receiving a transfer from a selected account through the use of readily accessible technology. The Point of Sale Transaction System and Method provides a highly flexible, universal and economical process for the payment/receipt and/or transfer of information, including, but not limited to electronic funds. The present invention provides added security to the use of cards by any number of users it also provides an alternative for people to use their cards easily and securely anywhere they have their communication device, among others.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF INVENTION

The present invention relates to point of sale transactions methods and systems in general and in particular to the use of electronic communication devices to facilitate a point of sale financial transaction.

### BACKGROUND OF THE INVENTION—DISCUSSION OF PRIOR ART

Communication devices have evolved from being used mainly to establish communication between parties to being used for a wide variety of applications. Through the use of the internet and other technologies, communication devices are now being used to perform many different transactions. Now days almost everyone owns a communication device, being it a cellular phone and/or any other hand held device.

Moreover, in today's society, where people are always in a rush and where forgetting your communication device is more of a hassle than forgetting to bring money or your credit cards with you, cell phones and other hand held devices have become more than a luxury, a necessity.

Thanks to advances in technology and because of safety concerns regarding robberies, people now days are more reluctant to travel with cash on their pockets, this is mainly why credit cards, debit cards and or other plastic cards were created.

Plastic cards having electronically stored data are widely used to perform a large variety of tasks, from being used as conventional credit, telephone, or bank cards to use as a security key to operate a door lock. Other types of cards are gasoline credit cards, building, room and or elevator security access cards, personnel cards, Automated Teller Machine (ATM) cards, debit cards and cash cards. For purposes of this application, however, these cards will be generically referenced as “authorization cards” or just “cards.”

Authorization cards fall into three general categories: magnetic, electronic or “smart cards,” and passive electronic cards. Confidential information, such as a unique account or card number, is typically stored on the card. In addition, the card number is printed on the face of the card, usually together with other security information such as the owner's name, the card's expiration date, and or a Personal Identification Number (PIN).

Although, being a great alternative to carrying cash, and/or other information, with these advances in technology, consumers soon became concern with identity theft, the reason being that in order to complete a given transaction at the point of sale, the card number and or other confidential information is transmitted from the card to a card reader for recognition and authorization by running the card through the card reader.

Also, when the card is located remote from the card reader, such as with transactions made by telephone, the confidential information cannot be swiped through the card reader. Hence, the card owner is forced to speak the card number, expiration date, user's name and or other confidential information to the seller. The seller then enters the confidential information into the card reader or other authorization device in order to charge a purchased item or service.

Verbally giving confidential information over a telephone risks the security of the information. An unauthorized user may overhear the user speaking the confidential information, or a prior charge receipt may be used without authorization. The unauthorized user may then repeat the confidential information to another remote seller in order to fraudulently charge the user's account.

Prior art for the usage of cards have generally required a user to carry his cards. This leaves the possibility of getting such cards stolen, lost, misplaced and misused. Moreover, submitting the information via telephone to third parties risks the security of confidential information.

Thereafter inventors created several types of systems or methods for configuring point of sale transactions using communication devices. For instance various systems use advanced technology such as infrared (IR) or Bluetooth technology. However, not every communication device that exists is capable of using these technologies without further enablement. As stated before, the use of communication devices, mainly cell phones, has become more of a standard in today's society. Accordingly, using these communication devices to engage in financial transactions is an alternative to using credit cards for a large number of consumers.

Moreover, the use of communication devices to perform these transactions makes users less dependable to their wallets and or credit cards, reducing the chances of your credit cards and or identity being stolen. Although there are communication devices enabled to perform transactions, these are mainly payment transactions and require high technology such as infrared or RF media. There are systems that allow for adapting an electronic transaction device to a point of sale terminal such as U.S. Pat. Nos. 6,705,520 and 6,769,607 that disclose an adapter for use with a POS card reader to interface with PDA's wireless phones and hand held devices trough infrared or RF media for conducting transactions.

### SUMMARY

Accordingly at least one of the following properties of this invention is to provide an accessible method for the use of communication devices to perform transactions. Such transactions may or may not be monetary in nature. This system and method facilitates the transaction to be completed, at the point of sale. The invention accordingly makes it possible for the user to either make a transaction, such as a payment or receive a payment from a selected account through the use of readily accessible technology.

Additional properties and advantages of this invention is to provide added security to the use of cards by any number of users, to provide a way for people to use their cards easily and securely anywhere they have their communication device, to provide an unlimited number of available security levels to the use of cards and/or accounts and to enable multiple authorized users to complete transactions with a plurality of cards and/or accounts. Also, higher level of security leads to less fraud or abuse. The invention will not depend on state of the art technology because it operates by means of accessible technology including at least one of, audio tones, audible signals. Still further properties and advantages will become apparent from a consideration of the ensuing description and drawings.

According to one aspect of the invention, a method to perform an instant point of sale transaction, comprises the use of audio tones to establish a communication link from a communication device located at a first location, receiving said communication link at a second location and generating a second signal which will validate a certain transaction trough the communication device, therefore enabling a user to remotely perform a certain transaction through its communication device at an instant point of sale.

According to further aspects of the invention, a system for completing a point of sale financial transaction comprises a communication device to generate a communication link; a server system to receive said communication link from said communication device and to generate a second signal for validating a transaction; and a terminal for identifying a registered user wherein the transaction is validated through said communication device.

The method and system of practicing the invention may include a terminal wherein the terminal is a cradle with an input and/or display device. In one method of practicing the invention, the transaction is performed without the need for a terminal and instead using another communication device for completing the transaction.

### BRIEF DESCRIPTION OF THE DRAWINGS

The preferred embodiments of the invention will hereinafter be described in conjunction with the included drawings provided to illustrate and not to limit the invention, wherein like designations denote like elements, and in which:

FIG. 1 shows a flow chart of the basic layout of the Method for generating a Point of Sale Transaction.

FIG. 2 shows a flow chart with an alternative Method for generating a Point of Sale Transaction wherein there is no terminal, and the transaction takes place via audio tones through adapting both communication devices inverted against each other.

FIG. 3 shows the basic layout of the System for generating a Point of Sale Transaction.

FIG. 4 shows an additional embodiment of the System for generating a Point of Sale Financial with an additional communication device connected directly to the server.

FIG. 5 shows an additional embodiment of the System for generating a Point of Sale Financial with an additional communication device permanently connected to the terminal.

FIG. 6 shows an additional embodiment of the Method for generating a Point of Sale Transaction with two communication devices, wherein there is no terminal, and the transaction takes place via audio tones through positioning both communication devices inverted against each other.

FIG. 7 shows an additional embodiment of the invention including an additional communication device.

FIG. 8 shows an additional embodiment of the invention with additional terminals and phones.

FIG. 9 shows an expanded version of the invention.

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

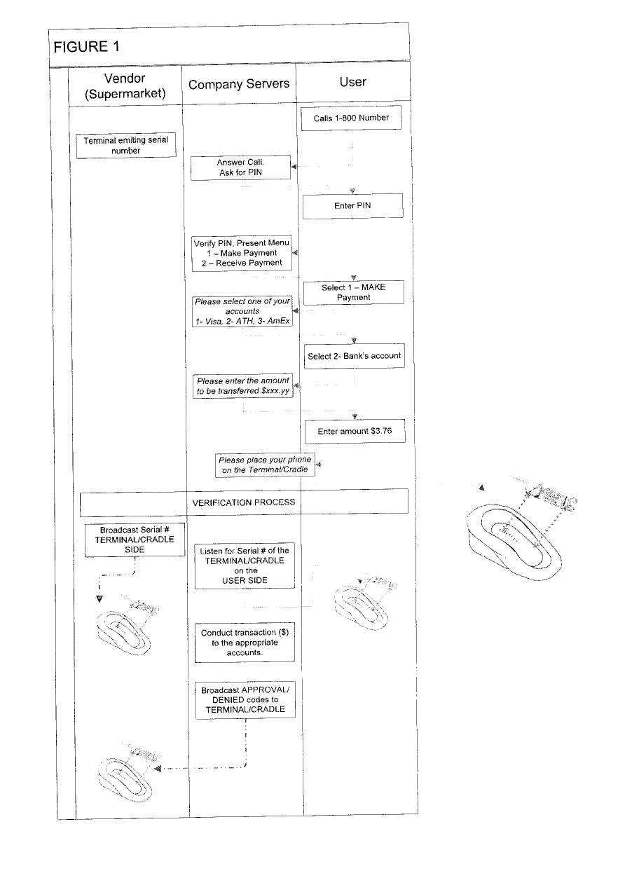

Disclosed in FIG. 1 is a flow chart with a view of the basic method for performing a Point of Sale Transaction. It represents the steps comprising the method for performing the transaction. Communicating among themselves, there's a server 20, the terminal 30, and a communication device 10. The server 20, could be a computer that relays the data packets in FIG. 1. The terminal 30, could be the destination of the electronic funds transfer. The communication device 10, which could be, at least one of the following, cellular phones, PCS phones, G3 phones, GSII phones, TDMA phones, CDMA phones, PDAs, computers, two/three-way pagers, wireless communication devices, communication gadgets, home/business phones, land line phones, etc., for purposes of this application all being referred to as “communication devices”.

As shown in FIG. 1, this preferred embodiment discloses the method for generating a point of sale transaction at an instant point of sale using a communication device.

As shown in FIG. 1, in order to practice this invention, the user must have been registered with the server. Registration may be performed personally, via telephone or via internet. During registration the user identifies which of his financial accounts he/she will like to register with the server system 20 and discloses or provides the server system with necessary information that corresponds to each of those financial accounts. The user will also have to register an identification code and the communication devices which will be allowed and/or registered with the server 20 to perform transactions related to those registered accounts. Once being registered, and when ready to perform the financial transaction, the user places a data packet link (phone call, reverse charge message SMS/MMS) with his communication device 10, to the server system 20. Through this data packet link, the server system 20, establishes communication with the communication device 10 and the terminal 30. Placing the data packet link causes the server system 20 to request from the user an identifier to identify the user with an account. Once the user has entered its identifier, such as, but not limited to a PIN number, the server system 20 compares the identifier with the information registered for that user. Once proper authentication has been verified, the server system provides the user with a menu wherein the user selects the kind of transaction he/she wishes to perform. Once the user has selected said transaction, the server 20 determines whether the user has the available funds and/or information needed to perform the selected transaction. The server system 20 then validates said transaction by producing a signal such as, but not limited to an audio tones. Said audio tone, either authorizing or declining said selected transaction, is then transmitted to the terminal 30, through the use of the communication device 10. The communication device 10 is then adapted to communicate with the terminal 30 which in turn identifies the registered user's account for that establishment to which the funds will ultimately be credited.

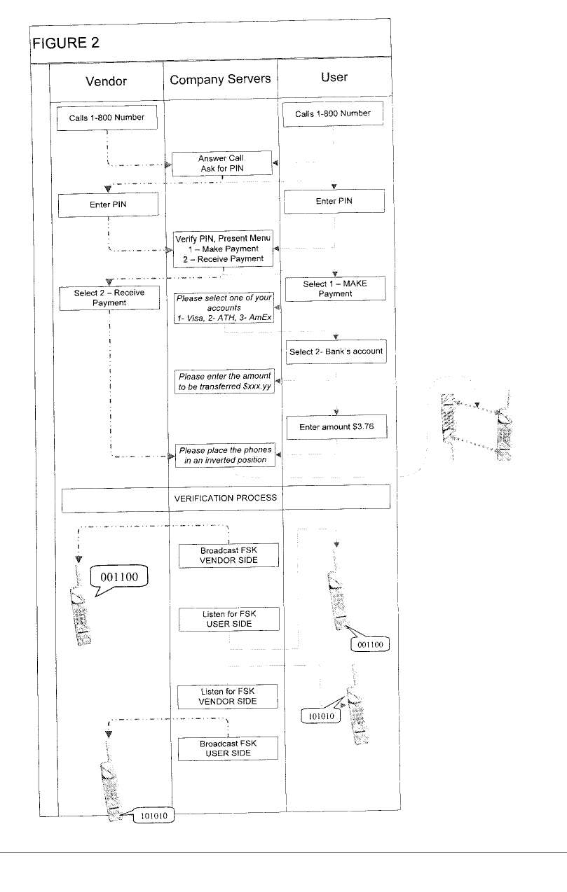

In one alternative embodiment of this invention, as shown in FIG. 2, the transaction is produced when two users, both registered with the server system decide to engage in a transaction wherein one will make a transfer and the other will receive the information and/or funds transferred by means of their communication devices. Basically users follow the same steps described hereinabove in FIG. 1 both independently, except that one user will choose the feature of making a transfer and the other will choose the feature of receiving a transfer, whichever it may be. Once each has gone through the menu and selected the desired application to be processed, then, the server system 20 will generate an audio signal for both communication devices and each will be placed inverted against the other in order for the server system 20 to identify each audio signal and to validate the transaction. In the preferred embodiment audio signals comprise audio tones. For instance, in a cellular phone the audio tones will be transmitted by the cellular speaker and the server's audio tone will be received by the cellular phone's microphone.

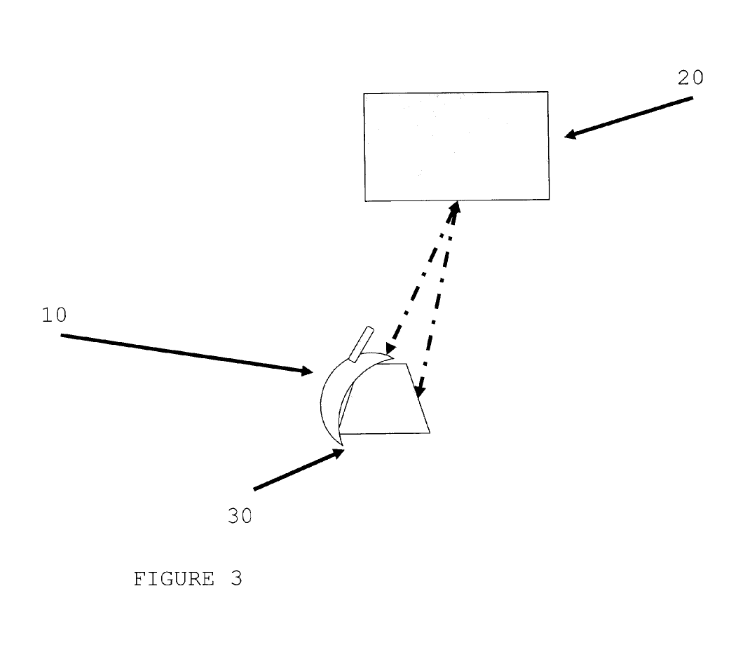

As shown in FIG. 3, the invention discloses a system for completing the point of sale financial transaction which comprises a communication device 10 that establishes a communication link; a server system 20, which in turn establishes another communication link with the terminal 30. The server system comprises all hardware or software necessary to allow the server to exchange information between at least two remotely located entities. The transaction is completed when, after receiving the validation signal from the server system 20, the communication device 10 is adapted to communicate with the terminal 30 and the necessary information is transferred to complete the transaction.

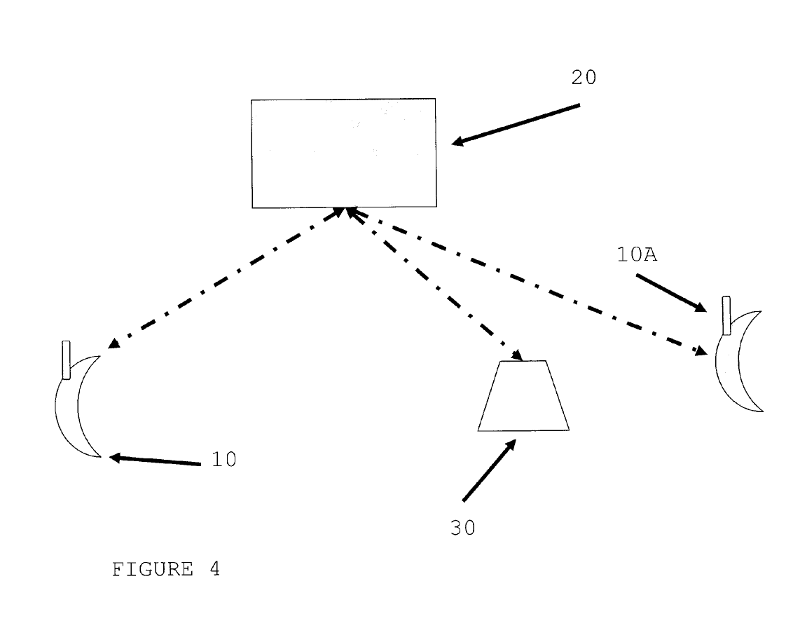

In an alternative embodiment of this invention, the same components of the systems described hereinabove in FIG. 3 are present, except that, as shown in FIG. 4, there is a communication device 10A permanently connected to the server system 20, through for example, but not limited to a dedicated line, thus the terminal 30 could be alternatively substituted by a communication device. In a preferred embodiment the communication device 10A could be implemented as a regular desk phone, however, it could be any other communication device that allows direct connection with the server 30.

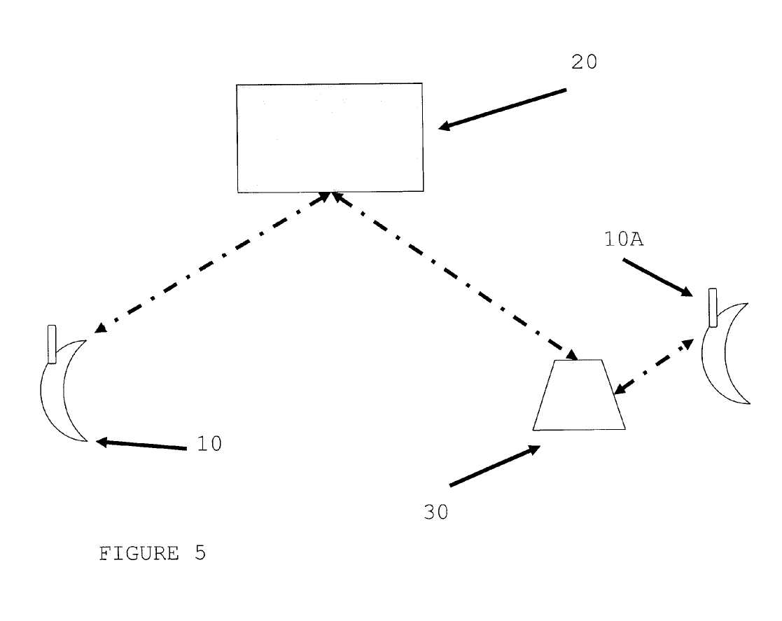

In an alternative embodiment of this invention, the same components of the systems described hereinabove in FIG. 3 are present, except that, as shown in FIG. 5, there is an additional communication device 10A permanently connected to the terminal 30 which is connected to the server system 20. Accordingly, this embodiment provides an alternative to non compatible communication devices in which the terminal 30 could be used instead. In a preferred embodiment the communication device 10A could be implemented as a regular desk phone, however, it could be any other communication device that allows direct connection with the server 30.

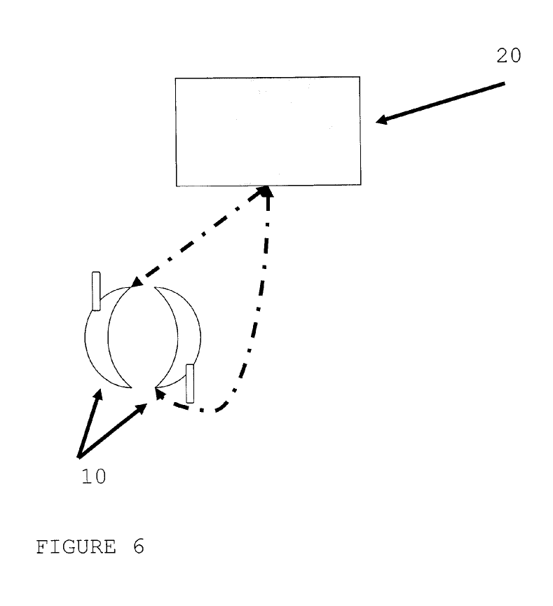

In one alternative embodiment as shown if FIG. 6 the electronic transfer can occur between the communication devices 10, by adapting both communication devices 10 inverted against each other in order for the server system 20 to identify each audio signal and to validate the transaction. In the preferred embodiment audio signals comprise audio tones. For instance, in a cellular phone the audio tones will be transmitted by the cellular speaker and the server's audio tone will be received by the cellular phone's microphone.

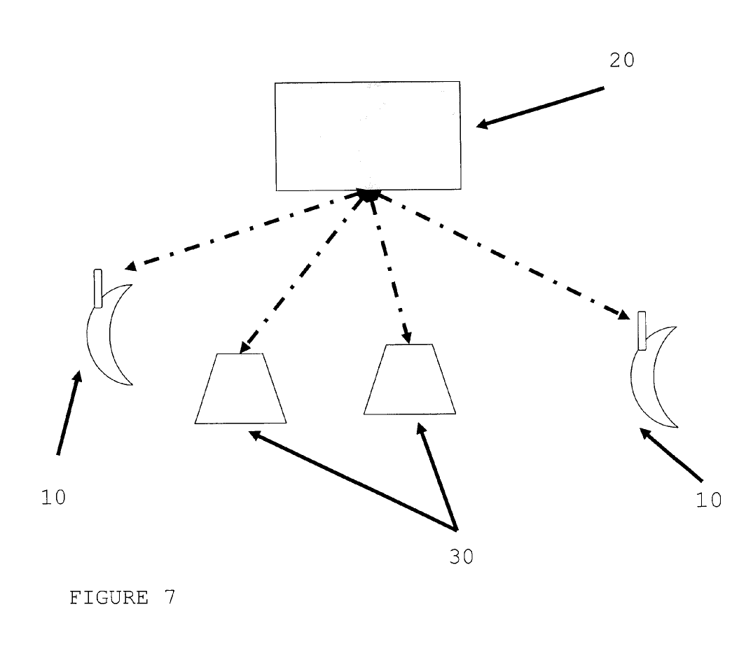

Disclosed in FIG. 7, an alternative embodiment represents the possibility of the electronic funds transfer through the System using two communication devices 10 and two terminals 30. This figure shows that the flexibility of the System layout is almost limitless.

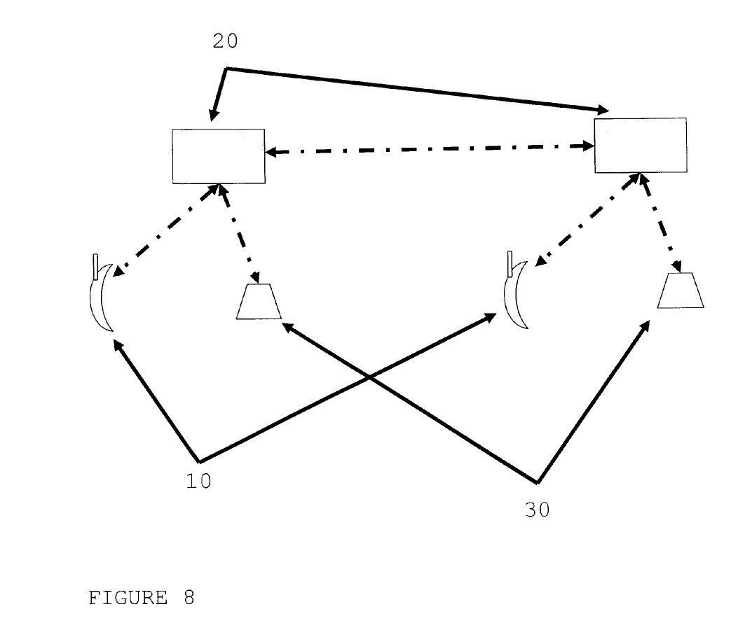

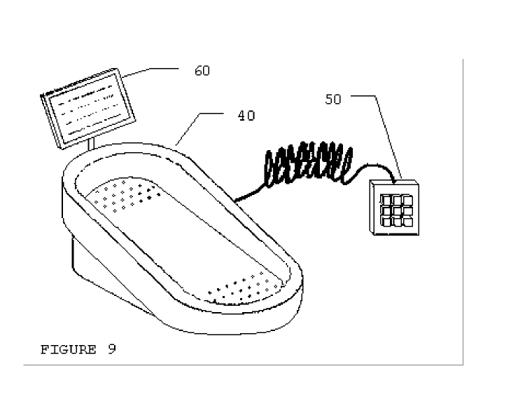

In an alternative embodiment as disclosed in FIG. 8, there are two servers 20, two communication devices 10, and two terminals 30. It is quite easy to see that there can be any number of the different parts of the system. FIG. 9 could represent the layout used when the system has a big customer base and needs redundancy, expanded support, increased capacity and other factors.

As shown in FIG. 9 the terminal 30 for conducting said financial transaction comprises a receiving device which could be at least one of the following: a cradle 40 with an input device 50 and a display device 60 among others.

As it is evident from the detail description, the present invention enables performing transactions and receiving transfers for goods and/or services to be made by a user through the use of a communication device.

The Point of Sale Transaction System and Method provides a highly flexible, universal and economical process for the payment/receipt and/or transfer of information, including, but not limited to electronic funds.

While my above description contains much specificity, these should not be construed as limitations on the scope of the invention, but rather as an exemplification of one preferred embodiment thereof. Many other variations are possible.

Although the invention has been described with reference to preferred embodiments, those skilled in the art will appreciate that many modifications are possible without departing from the scope of the invention. For example, the same basic system can be used by an employer to make sure that his employees arrive on time to work. If the employees are yard maintenance workers, then the head offices can ask that these employees call a 1-800 number and make a time-stamp with the customer's phone. So employees, customers and employers would use the system to authenticate on-time arrival.

Another example would be customers signing for received packages from the USPS, FedEx or UPS by means of the same system. They use their phones to authenticate a transaction.

Also this invention may be used within an ATM machine wherein the user performs the transaction by placing its communication device within a terminal within the ATM machine.

Accordingly, the scope of the invention should be determined not by the embodiments illustrated, but by the appended claims and their legal equivalents. Many other modifications are also possible. The following claims are intended to cover all such modifications and variations of the invention.

What is claimed is:

1. A method for generating a point of sale transaction comprising:
communicating from a first location with a server system located at a remote location;
processing said communicating with said server system at a remote location;
causing a financial transaction to be completed based on said processing of said communicating at said first location.

2. The method of claim 1, wherein, said communicating with said server comprises generating an identifier to identify a user based on said communicating and providing a menu.

3. The method of claim 2, wherein generating an identifier to identify comprises requesting an identification code and comparing said identification code with a predetermined code.

4. The method of claim 2, wherein said providing said menu comprises;
providing a list including a plurality of available functions;
selecting one of said plurality of available functions; and
sending indicia identifying said selected one of said plurality of functions.

5. The method of claim 4, wherein said providing a plurality of available functions comprises providing a list of functions including at least one of: making a transfer, receiving a transfer, making payment, receiving a payment, entering amount of transaction, and verify account balances.

6. The method of claim 2, further comprising selecting an account associated with the user.

7. The method of claim 6, wherein selecting said account associated with said user further comprises previously registering said account with a said server system.

8. The method of claim 3, further comprising registering said identification code with the server system.

9. The method of claim 1, wherein processing said communicating further comprises processing selected functions associated with a selected account and validating the transaction.

10. The method of claim 1, wherein said causing the financial transaction to be completed comprises;
generating a signal from a server system;
sending said signal to a communication device;
receiving said signal from said server system in said communication device;
converting said signal to an audio signal by the communication device.

11. The method of claim 1, wherein causing a transaction to be completed comprises adapting a communication device to communicate with a terminal.

12. The method of claim 11, wherein said adapting said communication device to communicate with said terminal comprises receiving an audio signal from the terminal corresponding to a terminal user and the amount of the transaction.

13. The method of claim 1, wherein said causing a transaction to be completed further comprises the server system receiving an audible signal from the terminal through the communication device and validating the transaction.

14. The method of claim 1 wherein causing a transaction to be completed further comprises debiting an amount from a selected account.

15. The method of claim 1, wherein said causing a transaction to be completed further comprises accrediting an amount to a terminal user account.

16. A method for generating a point of sale transaction comprising:
communicating from a first communication device with a server system located at a remote location;
processing said communicating from a first communication device with said server system at a remote location;
communicating from a second communication device with said server system located at said remote location;
processing said communicating from said second communication device with said server system at a remote location; and
causing a transaction to be completed based on said processing of said communicating from said first communication device and said processing of said communicating from said second communication device.

17. The method of claim 16, wherein, said communicating from said first communication device with said server system and said communicating from said second communication device with said server system comprises generating an identifier to identify a user based on said communicating and providing a menu, respectively.

18. The method of claim 17, wherein generating an identifier to identify comprises requesting an identification code and comparing said identification code with a predetermined code.

19. The method of claim 17, wherein said providing said menu comprises;
providing a list including a plurality of available functions;
selecting one of said plurality of available functions; and
sending indicia identifying said selected one of said plurality of functions.

20. The method of claim 19, wherein said providing a plurality of available functions comprises providing a list of functions including a at least one of: making a transfer, receiving a transfer, making payment, receiving a payment, entering amount of transaction, and verify account balances.

21. The method of claim 17, further comprising selecting an account associated with the user.

22. The method of claim 21, wherein selecting said account associated with said user further comprises previously registering said account with a the server system.

23. The method of claim 18, further comprising registering said identification code with the server system.

24. The method of claim 16, wherein processing said communicating from said first communication device and processing said communicating from said second communication device further comprises processing selected functions associated with a selected account and validating the transaction, respectively.

25. The method of claim 16, wherein said causing the transaction to be completed comprises;
generating a first signal from said server system based on said communicating from said first communication device;
sending said first signal to said first communication device;
receiving said first signal from said server system in said first communication device;
converting said first signal to an audio signal by said first communication device;
generating a second signal from said server system based on said communicating from said second communication device;
sending said second signal to said second communication device;
receiving said second signal from said server system in said second communication device;
converting said second signal to an audio signal by said second communication device.

26. The method of claim 16, wherein causing said transaction to be completed comprises adapting said first communication device to communicate with said second communication device.

27. The method of claim 16, wherein adapting said first communication device to communicate with said second communication device comprises positioning said first communication device inverted against said second communication device and allowing communication between said first communication device and said second communication device.

28. The method of claim 27, wherein allowing communication between said first communication device and said second communication device further comprises the use of audio tones.

29. The method of claim 16, wherein said causing said transaction to be completed comprises debiting a payment from a selected account.

30. The method of claim 16, wherein said causing a transaction comprises accrediting a payment to a selected account.

31. A system for completing a point of sale transaction comprising;
a communication device to generate a communication link;
a server system to receive said communication link from said communication device and to generate a signal for validating a transaction;
a terminal to receive said signal from said server system through said communication device and to process said signal to cause the transaction to be completed therein.

32. The system of claim 31, further comprising a receiving device linked to said server system, wherein information is transferred through said communication device for allowing said transaction to be completed.

33. A terminal for conducting a transaction from a remote location through a communication device, the terminal comprising a receiving element adapted to receive said communication device through which an identification code is transmitted to said server system.

34. The terminal of claim 33 wherein said receiving element further comprises at least one of the following, an input device, a display device and an audio device.

35. The terminal of claim 33 wherein said identification code is constantly transmitted at a substantial predetermined time rate.
